(19) United States
(12) Patent Application Publication
(10) Pub. No.: US 2026/0275082 A1
(43) Pub. Date: Sep. 17, 2026

(54) CURABLE COMPOSITION, CURED FILM USING SAME AND DISPLAY DEVICE INCLUDING CURED FILM

(71) Applicant: SAMSUNG SDI CO., LTD., Yongin-si, Gyeonggi-do (KR)

(72) Inventors: Kyunghee KANG, Yongin-si (KR); Yonghee KANG, Yongin-si (KR); Jihyeon YIM, Yongin-si (KR); Hyunjoo HAN, Yongin-si (KR); Chul-Kyu KIM, Yongin-si (KR); Sohyun KIM, Yongin-si (KR); Bumjin LEE, Yongin-si (KR)

(21) Appl. No.: 19/469,264

(22) PCT Filed: Mar. 13, 2024
(86) PCT No.: PCT/KR2024/003241

§ 371 Date: Sep. 25, 2025

(30) Foreign Application Priority Data
Mar. 29, 2023 (KR) 10-2023-0041366

(51) Int. Cl. C08K 9/04; C08K 3/00; C08K 5/04; C08K 11/00; C08L 101/00

(52) U.S. Cl. CPC C08K 9/04; C08K 3/00; C08K 5/04; C08K 11/00; C08L 101/00; C08K 2201/019

(57) ABSTRACT

Provided are a curable composition including (A) quantum dots; (B) a polymerizable compound; and (C) an electrolyte, and having an electrical conductivity of 0.1 μS/cm to 2.5 μS/cm, a cured layer produced using the same, and a display device including the cured layer.

### TECHNICAL FIELD

This disclosure relates to a curable composition, a cured layer using the composition, and a display device including the cured layer.

### BACKGROUND ART

In the case of general quantum dots, due to surface characteristics having hydrophobicity, a solvent in which it is dispersed is limited, and thus, it is difficult to introduce into a polar system such as a binder or a curable monomer.

For example, even in the case of a quantum dot ink composition being actively researched, a polarity is relatively low in an initial step and it may be dispersed in a solvent used in a curable composition having a high hydrophobicity. Therefore, because 20 wt % or more of quantum dots are difficult to be included based on a total amount of the composition, it is impossible to increase light efficiency of the ink over a certain level. Even though the quantum dots are additionally added and dispersed in order to increase light efficiency, a viscosity exceeds a range (12 cPs) capable of ink-jetting and thus processability may not be satisfied.

In order to achieve the viscosity range capable of ink-jetting, a method of lowering an ink solid content by dissolving 50 wt % or more of a solvent based on a total amount of the composition, which also provides a somewhat satisfactory result in terms of viscosity. However, it may be considered to be a satisfactory result in terms of a viscosity, but nozzle drying due to solvent volatilization, nozzle clogging, and reduction of a single layer as time passed after jetting may become worse and it is difficult to control a thickness deviation after curing. Thus, it is difficult to apply it to actual processes.

Therefore, a solvent-free quantum dot ink that does not include a solvent is the most desirable form to be applied to an actual process. The current technique of applying a quantum dot itself to a solvent-type composition is now limited to a certain extent.

As reported so far, it is difficult to increase light efficiency and absorption rate due to a limit of viscosity due to an amount of quantum dots in the case of the most desirable solvent-type composition for application to the actual process. Meanwhile, attempts have been made to lower the content of the quantum dot and increase the content of the light scatterer in other improvement approaches, but this has also failed to solve a sedimentation problem and a low light efficiency problem.

Accordingly, there is a growing need for a solvent-free composition. In the case of a solvent-free composition, reliability improvement such as luminance is urgently needed, such as pattern detachment due to a decrease in adhesion between the curing step or the subsequent process due to high shrinkage during curing.

### DISCLOSURE

### Technical Problem

An embodiment provides a curable composition capable of precise and reliable patterning without breakage during ink ejection.

Another embodiment provides a cured layer produced using the curable composition.

Another embodiment provides a display device including the cured layer.

### Technical Solution

An embodiment provides a curable composition including (A) quantum dots; (B) a polymerizable compound; and (C) an electrolyte, and having an electrical conductivity of 0.1 μS/cm to 2.5 μS/cm.

The electrolyte may include an ionic compound, a conductive polymer, or a combination thereof.

The ionic compound may be a compound composed of a combination of a cation and an anion, and the cation may be any one cation selected from Group 1.

### [Group 1]

a substituted or unsubstituted ammonium, a substituted or unsubstituted imidazolium, a substituted or unsubstituted oxazolium, a substituted or unsubstituted piperidinium, a substituted or unsubstituted pyrazinium, a substituted or unsubstituted pyrazolium, a substituted or unsubstituted pyridazinium, a substituted or unsubstituted pyridinium, a substituted or unsubstituted pyrimidinium, a substituted or unsubstituted pyrrolidinium, a substituted or unsubstituted pyrrolinium, a substituted or unsubstituted pyrrolium, a substituted or unsubstituted triazolium, and

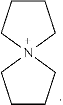

The ionic compound may be a compound composed of a combination of a cation and an anion, and the anion may be any one anion selected from Group 2:

### [Group 2]

F⁻, Cl⁻, Br⁻, I⁻, Br₃⁻, NO₃⁻, N(CN)₂⁻, BF₄⁻, ClO₄⁻, FCrO₃⁻, ClCrO₃⁻, SO₄², RSO₃⁻ (wherein R is a C1 to C10 alkyl group or a C6 to C20 aryl group), RCOO⁻ (wherein R is a C1 to C10 alkyl group or a C6 to C20 aryl group), H₂PO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, (CF₃SO₃⁻)₂, (CF₂CF₂SO₃⁻)₂, (CF₃SO₃)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, and CH₃CO₂⁻.

The ionic compound may include an ionic liquid, a solid ionic salt, or a combination thereof.

The conductive polymer may include at least one selected from the group consisting of polyphenylene or a derivative thereof, polyphenylenevinylene or a derivative thereof, polyphenylene sulfide or a derivative thereof, polyfluorene or a derivative thereof, poly(p-pyridine) or a derivative thereof, poly(p-pyridal vinylene) or a derivative thereof, polypyrrole or a derivative thereof, polyaniline or a derivative thereof, polythiophene or a derivative thereof, polythiophenvinylene or a derivative thereof, polyfuran or a derivative thereof, and polyacetylene or a derivative thereof.

The electrolyte may be included in an amount of 0.1 wt % to 1 wt % based on the total amount of the curable composition.

The polymerizable compound may include a compound represented by Chemical Formula 1.

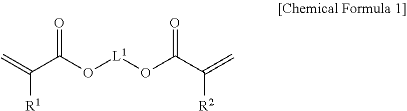

In Chemical Formula 1,
R¹ and R² are each independently a hydrogen atom or a methyl group, and
L¹ is a substituted or unsubstituted C1 to C30 alkylene group or *-L^{a}-O-L^{b}-* (wherein L^{a} and L^{b} are each independently a substituted or unsubstituted C1 to C20 alkylene group).

The compound represented by Chemical Formula 1 may be represented by any one of Chemical Formulas 1-1 to 1-3.

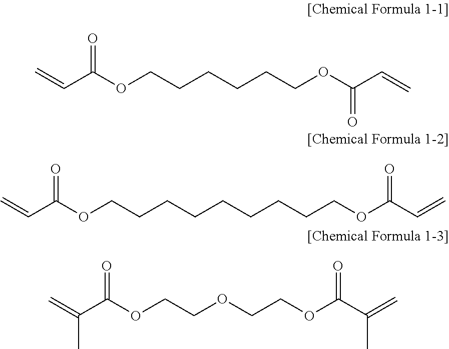

The quantum dots may be surface-modified quantum dots with any one of compounds represented by Chemical Formulas 2 to 15 or a combination thereof.

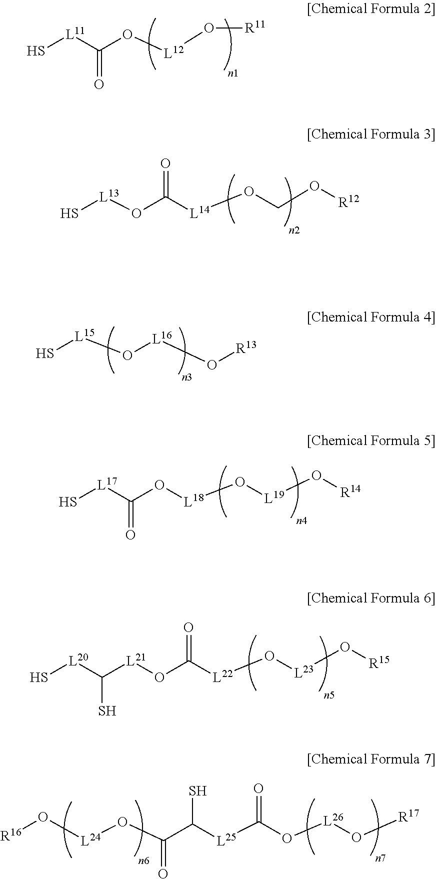

In Chemical Formulas 2 to 7,
R¹¹ to R¹⁷ are each independently a substituted or unsubstituted C1 to C10 alkyl group or a substituted or unsubstituted C6 to C20 aryl group,
L¹¹ to L²⁶ are each independently a substituted or unsubstituted C1 to C10 alkylene group, and
n1 to n7 are each independently an integer of 0 to 10,

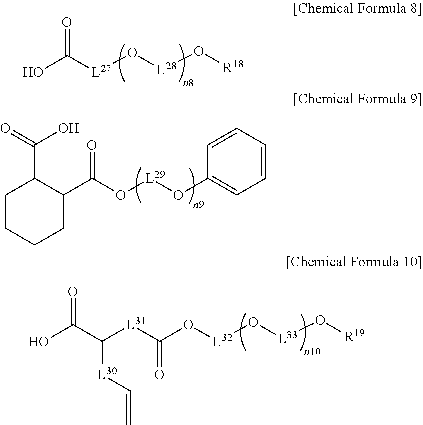

wherein, in Chemical Formulas 8 to 10,
R¹⁸ and R¹⁹ are each independently a substituted or unsubstituted C1 to C10 alkyl group,
L²⁷ to L³³ are each independently a substituted or unsubstituted C1 to C10 alkylene group, and
n8 to n10 are each independently an integer of 0 to 10,

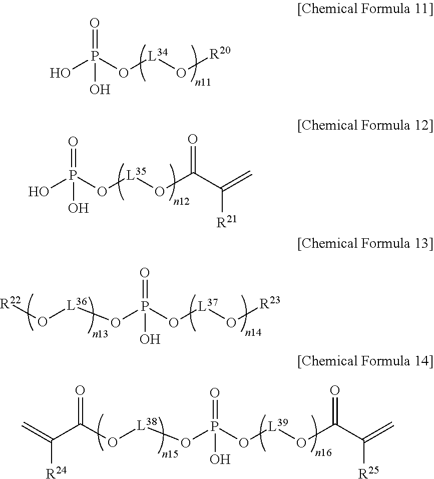

wherein, in Chemical Formulas 11 to 14,
R²⁰ to R²⁵ are each independently a hydrogen atom or a substituted or unsubstituted C1 to C10 alkyl group,
L³⁴ to L³⁹ are each independently a substituted or unsubstituted C1 to C10 alkylene group, and
n11 to n16 are each independently an integer of 0 to 10,

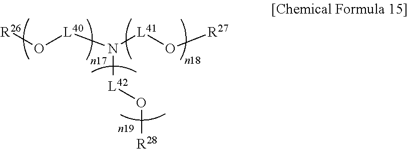

wherein, in Chemical Formula 15,
R²⁶ to R²⁸ are each independently a substituted or unsubstituted C1 to C10 alkyl group,
L⁴⁰ to L⁴² are each independently a substituted or unsubstituted C1 to C10 alkylene group, and
n17 to n19 are each independently an integer of 0 to 10.

The quantum dots may have a maximum fluorescence emission wavelength at 500 nm to 680 nm.

The curable composition may further include a light scatterer.

The light scatterer may further include barium sulfate, calcium carbonate, titanium dioxide, zirconia, or a combination thereof.

The curable composition may be a solvent-free curable composition.

The quantum dots may be included in an amount of 5 wt % to 70 wt % based on a total weight of the solvent-free curable composition.

The polymerizable compound may be included in an amount of 30 wt % to 95 wt % based on a total weight of the solvent-free curable composition.

The curable composition may further include a polymerization initiator.

The curable composition may further include a solvent.

The curable composition may include 1 wt % to 40 wt % of the (A) quantum dots; 1 wt % to 20 wt % of the (B) polymerizable compound; 0.1 wt % to 1 wt % of the (C) electrolyte; and 40 wt % to 80 wt % of the solvent based on a total weight of the curable composition.

The curable composition may further include a polymerization inhibitor; malonic acid; 3-amino-1,2-propanediol; a silane-based coupling agent; a leveling agent; a fluorine-based surfactant; or a combination thereof.

Another embodiment provides a cured layer produced using the curable composition.

Another embodiment provides a display device including the cured layer.

Other embodiments of the present invention are included in the following detailed description.

### Advantageous Effects

It is possible to provide a curable composition having very excellent ink jetting stability as electrospinning proceeds stably.

### BEST MODE

Hereinafter, embodiments of the present invention are described in detail. However, these embodiments are exemplary, the present invention is not limited thereto and the present invention is defined by the scope of claims.

In the present specification, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

In the present specification, when specific definition is not otherwise provided, “substituted” refers to replacement of at least one hydrogen atom by a substituent selected from a halogen atom (F, Cl, Br, or I), a hydroxy group, a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

In the present specification, when specific definition is not otherwise provided, “hetero” refers to inclusion of at least one heteroatom of N, O, S, and P, in the chemical formula.

In the present specification, when specific definition is not otherwise provided, “(meth)acrylate” refers to both “acrylate” and “methacrylate”, and “(meth)acrylic acid” refers to “acrylic acid” and “methacrylic acid”.

In the present specification, when specific definition is not otherwise provided, the term “combination” refers to mixing or copolymerization.

In the present specification, when a definition is not otherwise provided, hydrogen is bonded at the position when a chemical bond is not drawn in chemical formula where supposed to be given.

In the present specification, when a definition is not otherwise provided, “*” refers to a linking point with the same or different atom or chemical formula.

The curable composition according to an embodiment includes (A) quantum dots; (B) a polymerizable compound; and (C) an electrolyte, wherein the curable composition has an electrical conductivity of 0.1 μS/cm to 2.5 μS/cm.

In order to secure dispersibility of the quantum dots, in general, a solvent is used to disperse the quantum dots, but there are problems such as nozzle drying, deterioration of ink-jetting processibility, generation of marginal efficiency due to limitation of an injectable content of the quantum dots, and the like. In order to solve these problems, efforts to develop a solvent-free quantum dot ink composition including no solvent have been made, but since technology of dispersing the quantum dots themselves in the solvent-free quantum dot ink composition is currently evaluated to have reached a certain limit as described above and since the content of the quantum dots injected in the composition also has reached a limit of 20 wt % to 25 wt % or so, it is not easy to improve optical characteristics to a higher level.

In order to improve the optical characteristics, efforts to apply a high content of solid quantum dots in the solvent-free composition through surface modification have been made but inevitably accompany an increase in viscosity of the composition, greatly deteriorating the ink-jetting properties. Accordingly, in order to lower the increased viscosity to an ink-jettable level, required are methods of reducing the solid content of the quantum dots or increasing a temperature of a head through which an ink is jetted. However, when the solid content of the quantum dots is reduced, the optical characteristics may be deteriorated, but when the head temperature is increased, ejection property during the ink-jetting may be deteriorated, which may cause inferior adhesion.

Furthermore, an electrohydrodynamic (EHD) jet printing technology has emerged. This is a direct-writing method of discharging/spraying an ink through an electrohydrodynamic force by using an electricfield, which has, compared with a conventional inkjet printing method, advantages such as nano-scale high-resolution characteristics, a fast printing speed, application ranges of various inks, and the like and thus may be used to manufacture micro- or nano-sized structures and patterns in various shapes and sizes, attracting attentions as a next-generation printing technology.

The present invention relates to a high-viscosity quantum dot-containing ink composition sufficiently applicable not only to the conventional inkjet printing but also to the EHD jet printing and thus finally capable of precise and highly reliable patterning without breakage during the ink jetting.

Conventionally, since lots of efforts have been concentrated on changing a structure or content of quantum dots or a polymerizable compound and surface-modifying them, etc. but have no notable improvement particularly in terms of ink jetting stability, the present inventors have paid attentions to an electrical conductivity of a curable composition itself essentially including the quantum dots and the polymerizable compound. In other words, the present inventors have found that the electrical conductivity of the curable composition may be controlled to smoothly and stably perform electrospinning, which may accumulate and maintain an ink solution continuously discharged during the ink jetting in a fibrous form, and resultantly, greatly improve the ink jetting stability and then, have confirmed through repeated research that the electrical conductivity of the curable composition may be controlled within a range of 0.1 μS/cm to 2.5 μS/cm by adding an electrolyte to the curable composition to realize excellent ink jetting properties, completing the present invention. When the curable composition including the electrolyte has electrical conductivity of less than 0.1 μS/cm or greater than 2.5 μS/cm, the ink jetting stability may be greatly deteriorated.

Hereinafter, each component is described in detail.

### (C) Electrolyte

Since an electrolyte is a material that conducts electricity by forming ions, when mixed with a material having polarity, according to one embodiment, the electrolyte forms ions, when mixed with the polymerizable compound, easily controlling the electrical conductivity of the curable composition within a range of 0.1 μS/cm to 2.5 μS/cm and thereby, greatly improving ink jetting properties.

For example, the electrolyte may include an ionic compound, a conductive polymer, or a combination thereof.

The ionic compound is a compound composed of a combination of a cation and an anion, and the cation may be any one cation selected from Group 1, and the anion may be any one anion selected from Group 2.

### [Group 1]

a substituted or unsubstituted ammonium, a substituted or unsubstituted imidazolium, a substituted or unsubstituted oxazolium, a substituted or unsubstituted piperidinium, a substituted or unsubstituted pyrazinium, a substituted or unsubstituted pyrazolium, a substituted or unsubstituted pyridazinium, a substituted or unsubstituted pyridinium, a substituted or unsubstituted pyrimidinium, a substituted or unsubstituted pyrrolidinium, a substituted or unsubstituted pyrrolinium, a substituted or unsubstituted pyrrolium, a substituted or unsubstituted triazolium, and

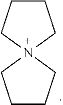

### [Group 2]

F⁻, Cl⁻, Br⁻, I⁻, Br₃−, NO₃⁻, N(CN)₂⁻, BF₄⁻, ClO₄⁻, FCrO₃⁻, ClCrO₃⁻, SO₄²⁻, RSO₃⁻ (wherein R is a C1 to C10 alkyl group or a C6 to C20 aryl group), RCOO⁻ (wherein R is a C1 to C10 alkyl group or a C6 to C20 aryl group), H₂PO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, (CF₃SO₃⁻)₂, (CF₂CF₂SO₃⁻)₂, (CF₃SO₃)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, and CH₃CO₂⁻.

For example, the cation may be substituted with a substituent such as a halogen element, an alkyl group, or an aryl group. For example, the substituted or unsubstituted ammonium may be NH₄⁺ or may be a tetrabutylammonium cation substituted with four butyl groups.

For example, the ionic compound may include an ionic liquid, a solid ionic salt, or a combination thereof. Herein, the solid ionic salt may mean a solid ionic salt at room temperature (20° C. to 25° C.). Among the ionic compounds, the ionic liquid may be more advantageous than the solid ionic salt in terms of controlling electrical conductivity of the curable composition.

For example, the conductive polymer may include at least one selected from polyphenylene or a derivative thereof, polyphenylenevinylene or a derivative thereof, polyphenylene sulfide or a derivative thereof, polyfluorene or a derivative thereof, poly(p-pyridine) or a derivative thereof, poly(p-pyridal vinylene) or a derivative thereof, polypyrrole or a derivative thereof, polyaniline or a derivative thereof, polythiophene or a derivative thereof, polythiophenvinylene or a derivative thereof, polyfuran or a derivative thereof, and polyacetylene or a derivative thereof.

For example, among the electrolytes, the ionic compound may be more advantageous than the conductive polymer in terms of controlling the electrical conductivity of the curable composition.

For example, the solid-phased ionic salt in the electrolyte, compared with the conductive polymer, has a wide electrical conductivity range of the curable composition capable of maintaining excellent ink jetting properties, and the ionic liquid has a wider electrical conductivity range of the curable composition capable of maintaining excellent ink jetting properties than the solid-phased ionic salt.

For example, the electrolyte may be included in an amount of 0.1 wt % to 1 wt % based on a total amount of the curable composition. Specifically, the ionic liquid in the electrolyte may be included in an amount of 0.1 wt % to 0.5 wt %, for example, 0.1 wt % to 0.3 wt %, based on a total amount of the curable composition, the solid ionic salt in the electrolyte may be included in an amount of 0.1 wt % to 0.5 wt %, for example, 0.1 wt % to 0.3 wt % based on a total amount of the curable composition, and the conductive polymer in the electrolyte may be included in an amount of 0.1 wt % to 0.5 wt %, for example, 0.1 wt % to 0.3 wt %, based on a total amount of the curable composition. The final electrical conductivity of the curable composition may be easily controlled within the range of 0.1 μS/cm to 2.5 μS/cm only when the electrolyte is included in the above ranges.

### (B) Polymerizable Compound

The curable composition according to an embodiment may include a polymerizable compound, and the polymerizable compound may have a carbon-carbon double bond at its terminal end.

The polymerizable compound having the carbon-carbon double bond at the terminal end may be included in an amount of 30 wt % to 95 wt %, for example, 40 wt % to 90 wt %, based on a total amount of the solvent-free curable composition. If the polymerizable compound having the carbon-carbon double bond at the terminal end is included within the ranges, a solvent-free curable composition having a viscosity that enables ink-jetting may be prepared and the quantum dots in the prepared solvent-free curable composition may have improved dispersibility, thereby improving optical characteristics.

For example, the polymerizable compound having the carbon-carbon double bond at the terminal end may have a molecular weight of 170 g/mol to 1,000 g/mol. When the molecular weight of the polymerizable compound having a carbon-carbon double bond at the terminal end is within the above range, it is advantageous for ink-jetting because it does not impair optical characteristics of the quantum dots and does not increase the viscosity of the composition.

For example, the polymerizable compound having a carbon-carbon double bond at the terminal end may be represented by Chemical Formula 1, but is not necessarily limited thereto.

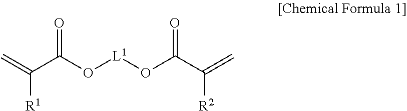

In Chemical Formula 1,
R¹ and R² are each independently a hydrogen atom or a methyl group,
L¹ is a substituted or unsubstituted C1 to C30 alkylene group or *-L^{a}-O-L^{b}-* (wherein L^{a} and L^{b} are each independently a substituted or unsubstituted C1 to C20 alkylene group).

For example, the polymerizable compound having the carbon-carbon double bond at the terminal end may be represented by any one of Chemical Formulas 1-1 to 1-3, but is not necessarily limited thereto.

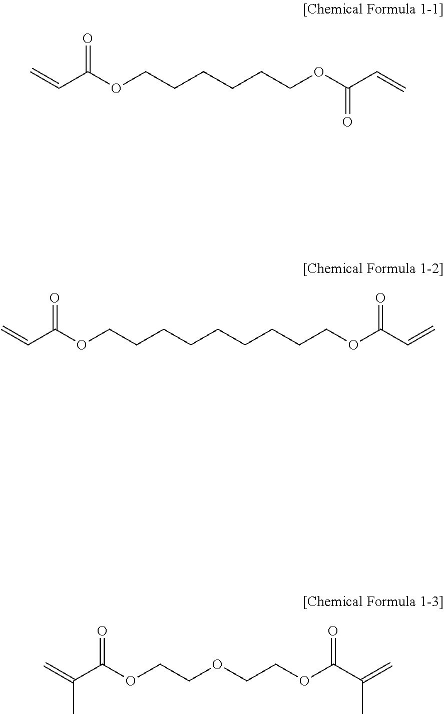

For example, the polymerizable compound having the carbon-carbon double bond at the terminal end may further include ethylene glycoldiacrylate, triethylene glycoldiacrylate, 1,4-butanedioldiacrylate, 1,6-hexanedioldiacrylate, neopentylglycoldiacrylate, pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolac epoxyacrylate, ethylene glycoldimethacrylate, triethylene glycoldimethacrylate, propylene glycoldimethacrylate, 1,4-butanedioldimethacrylate, 1,6-hexanedioldimethacrylate, or a combination thereof in addition to the aforementioned compound of Chemical Formula 1-1 or 1-3.

In addition, together with the polymerizable compound having the carbon-carbon double bond at the terminal end, a generally-used monomer of a conventional thermosetting or photocurable composition may be further included. For example the monomer further include an oxetane-based compound such as bis[1-ethyl (3-oxetanyl)]methyl ether, and the like.

In addition, when the curable composition is a solvent-type curable composition including a solvent, the polymerizable compound may be included in an amount of 1 wt % to 20 wt %, 1 wt % to 15 wt %, for example, 5 wt % to 15 wt % based on a total amount of the solvent-type curable composition. If the polymerizable compound is included within the above range, optical characteristics of the quantum dots may be improved.

### (A) Quantum Dots

The quantum dots in the curable composition according to an embodiment may be quantum dots surface-modified with a ligand having a polar group, for example, a ligand having high affinity with the polymerizable compound. In the case of the surface-modified quantum dots as described above, it is very easy to prepare a high-concentration or highly-concentrated quantum dot dispersion (improving the dispersibility of the quantum dots in the polymerizable compound), which can have a great effect on improving the light efficiency and particularly, may be advantageous to implement a solvent-free curable composition.

For example, the ligand having the polar group may have a structure having high affinity with the chemical structure of the polymerizable compound.

For example, the ligand having the polar group may be any one of compounds represented by Chemical Formulas 2 to 15 or a combination thereof, but is not necessarily limited thereto.

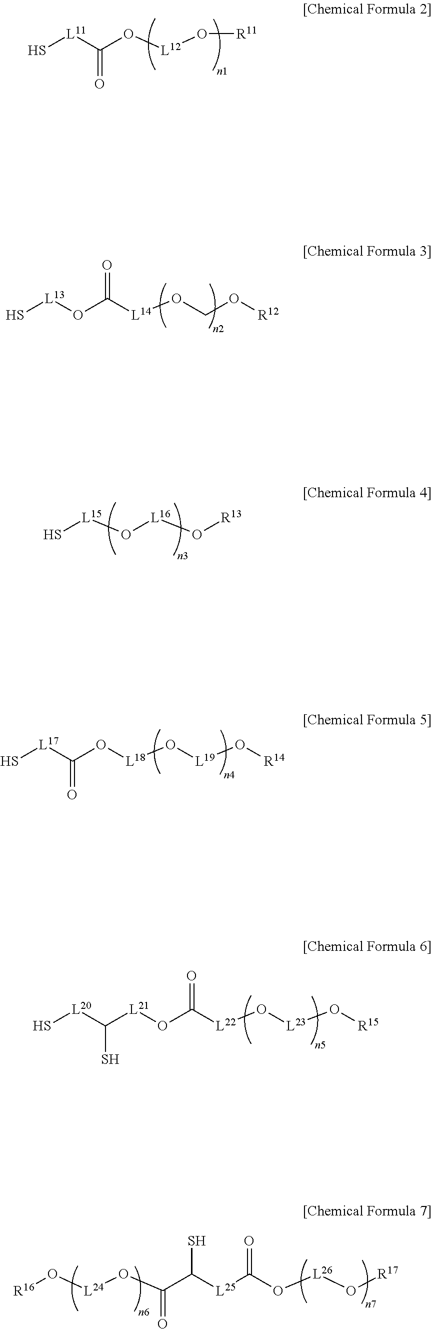

In Chemical Formulas 2 to 7,
R¹¹ to R¹⁷ are each independently a substituted or unsubstituted C1 to C10 alkyl group or a substituted or unsubstituted C6 to C20 aryl group,
L¹¹ to L²⁶ are each independently a substituted or unsubstituted C1 to C10 alkylene group, and
n1 to n7 are each independently an integer of 0 to 10,

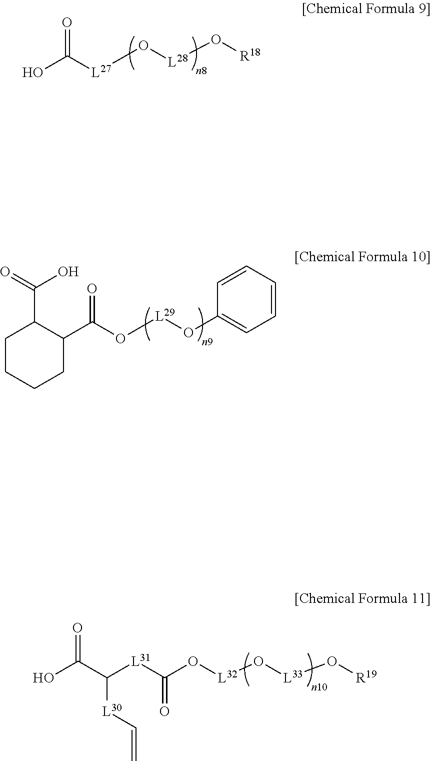

wherein, in Chemical Formulas 8 to 10,
R¹⁸ and R¹⁹ are each independently a substituted or unsubstituted C1 to C10 alkyl group,
L²⁷ to L³³ are each independently a substituted or unsubstituted C1 to C10 alkylene group, and
n8 to n10 are each independently an integer of 0 to 10,

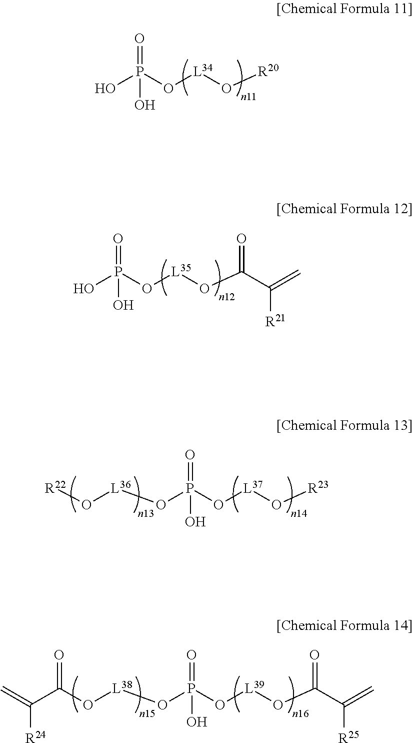

wherein, in Chemical Formulas 11 to 14,
R²⁰ to R²⁵ are each independently a hydrogen atom or a substituted or unsubstituted C1 to C10 alkyl group,
L³⁴ to L³⁹ are each independently a substituted or unsubstituted C1 to C10 alkylene group, and
n11 to n16 are each independently an integer of 0 to 10,

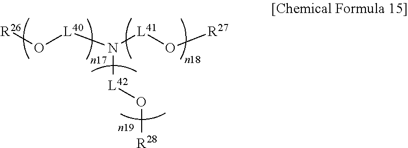

wherein, in Chemical Formula 15,
R²⁶ to R²⁸ are each independently a substituted or unsubstituted C1 to C10 alkyl group,
L⁴⁰ to L⁴² are each independently a substituted or unsubstituted C1 to C10 alkylene group, and
n17 to n19 are each independently an integer of 0 to 10.

For example, the compounds represented by Chemical Formulas 2 to 15 may be represented by any one of the compounds represented by Chemical Formulas A to Q, but are not necessarily limited thereto.

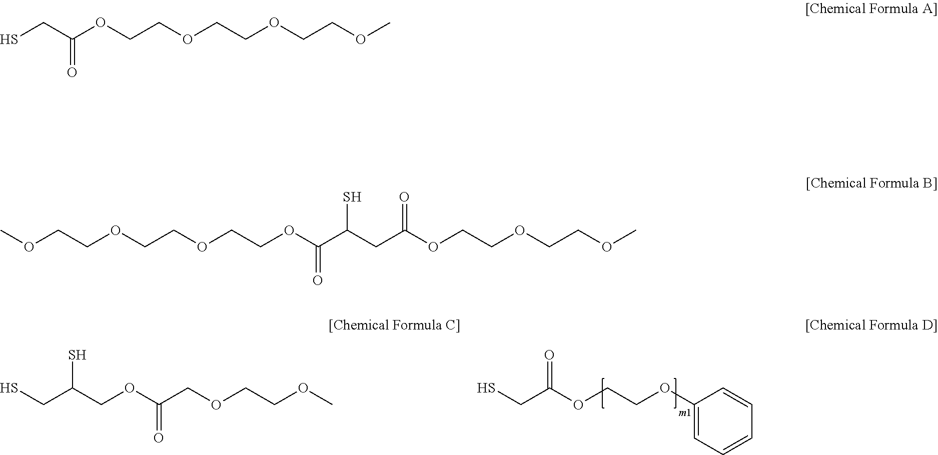

(In Chemical Formula D, m1 is an integer from 0 to 10.)

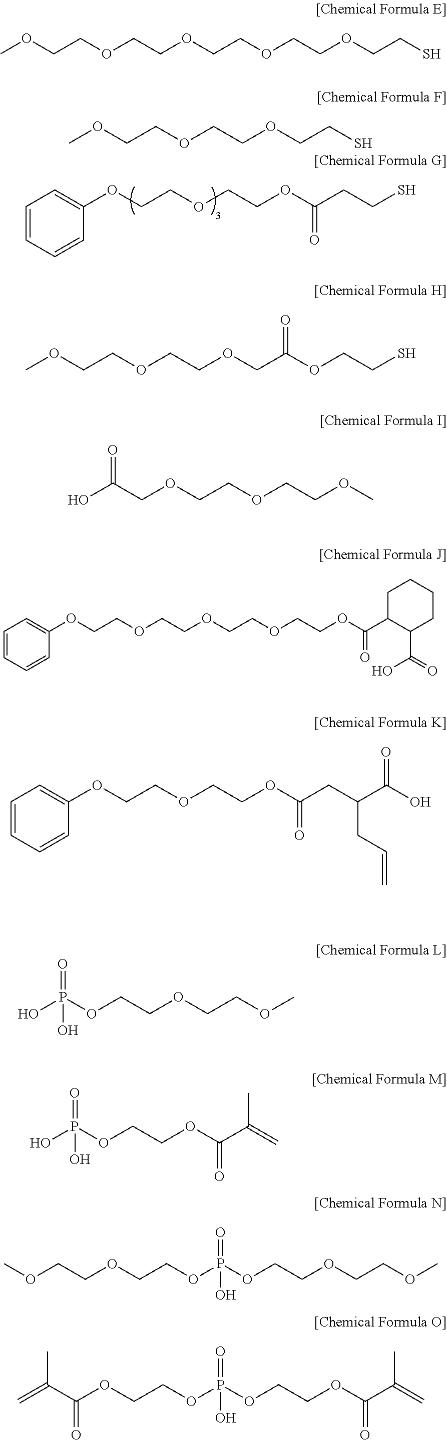

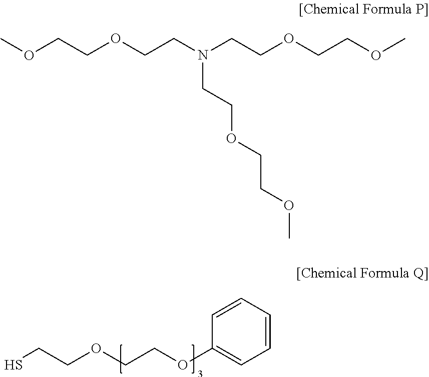

When the ligand is used, the surface modification of the quantum dots is easier, and when the quantum dots surface-modified with the ligand are added to the above-described polymerizable compound and stirred, a very transparent dispersion may be obtained, which indicates that the surface modification of the quantum dots is very good.

For example, when the curable composition according to an embodiment is a solvent-free curable composition, the quantum dots may be included in an amount of 5 wt % to 70 wt %, for example 10 wt % to 60 wt %, for example 20 wt % 10 to 60 wt %, or for example 30 wt % to 50 wt %. If the quantum dots are included within the range, a high light retention rate and light efficiency can be achieved even after curing.

For example, when the curable composition according to an embodiment is a solvent-type curable composition including a solvent, the quantum dots may be included in an amount of 1 wt % to 40 wt %, or for example 3 wt % to 30 wt %, based on a total amount of the curable composition. If the quantum dots are included within the above range, the light conversion rate is improved and pattern characteristics and development characteristics are not impaired, so that excellent processibility may be obtained.

For example, the quantum dots absorb light in a wavelength region of 360 nm to 780 nm, for example 400 nm to 780 nm and emits fluorescence in a wavelength region of 500 nm to 700 nm, or for example 500 nm to 580 nm, or emits fluorescence in a wavelength region of 600 nm to 680 nm. That is, the quantum dots may have a maximum fluorescence emission wavelength (fluorescence λₑₘ) at 500 nm to 680 nm.

The quantum dots may each independently have a full width at half maximum (FWHM) of 20 nm to 100 nm, or for example 20 nm to 50 nm. If the quantum dots have a full width at half maximum (FWHM) of the ranges, color reproducibility is increased when used as a color material in a color filter due to high color purity.

The quantum dots may each independently be an organic material, an inorganic material, or a hybrid (mixture) of an organic material and an inorganic material.

The quantum dots may each independently be composed of a core and a shell surrounding the core, and the core and the shell may each independently have a structure of a core, core/shell, core/first shell/second shell, alloy, alloy/shell, or the like, which is composed of Group II-IV, Group III-V, and the like, but are not limited thereto.

For example, the core may include at least one material selected from CdS, CdSe, CdTe, ZnS, ZnSe, ZnTe, HgS, HgSe, HgTe, GaN, GaP, GaAs, InP, InAs, and an alloy thereof, but is not necessarily limited thereto. The shell surrounding the core may include at least one material selected from CdSe, ZnSe, ZnS, ZnTe, CdTe, PbS, TiO, SrSe, HgSe, and an alloy thereof, but is not necessarily limited thereto.

In an embodiment, since an interest in an environment has been recently much increased over the whole world, and a restriction of a toxic material also has been fortified, a cadmium-free light emitting material (InP/ZnS, InP/ZnSe/ZnS, etc.) having little low quantum efficiency (quantum yield) but being environmentally-friendly instead of a light emitting material having a cadmium-based core is used, but not necessarily limited thereto.

In the case of the quantum dots of the core/shell structure, an entire size including the shell (an average particle diameter) may be 1 nm to 15 nm, for example, 5 nm to 15 nm.

For example, the quantum dots may each independently include red quantum dots, green quantum dots, or a combination thereof. The red quantum dots may each independently have an average particle diameter of 10 nm to 15 nm. The green quantum dots may each independently have an average particle diameter of 5 nm to 8 nm.

On the other hand, for dispersion stability of the quantum dot, the curable composition according to an embodiment may further include a dispersant. The dispersant helps uniform dispersibility of light conversion materials such as quantum dots in the curable composition and may include a non-ionic, anionic, or cationic dispersant. Specifically, the dispersant may be polyalkylene glycol or esters thereof, a polyoxy alkylene, a polyhydric alcohol ester alkylene oxide addition product, an alcohol alkylene oxide addition product, a sulfonate ester, a sulfonate salt, a carboxylate ester, a carboxylate salt, alkyl amide alkylene oxide addition product, alkyl amine and the like, and they may be used alone or in a mixture of two or more. The dispersant may be used in an amount of 0.1 wt % to 100 wt %, or for example 10 wt % to 20 wt % based on a solid content of the light conversion material such as quantum dots.

### Light Scatterer

The curable composition according to an embodiment may further include a light scatterer.

That is, the light scatterer may increase the light conversion efficiency of the curable composition by increasing the amount of light absorbed by the quantum dots.

For example, the light scatterer may include barium sulfate (BaSO₄), calcium carbonate (CaCO₃), titanium dioxide (TiO₂), zirconia (ZrO₂), or a combination thereof, but is not necessarily limited thereto.

For example, the light scatterer may be included in an amount of 1 wt % to 10 wt %, for example 2 wt % to 8 wt %, for example 3 wt % to 7 wt %, or for example 4 wt % to 6 wt % based on a total amount (100 wt %) of the curable composition (solvent-free curable composition). If the amount of the light scattering material is within the above range, luminance of the curable composition may be greatly improved and the sedimentation stability of the quantum dots may be improved.

For example, the curable composition according to an embodiment may be a solvent-free curable composition or a solvent-type curable composition including a solvent.

### Polymerization Initiator

The curable composition according to an embodiment may further include a polymerization initiator, for example, a photopolymerization initiator, a thermal polymerization initiator, or a combination thereof.

The photopolymerization initiator is a generally-used initiator for a curable composition, for example an acetophenone-based compound, a benzophenone-based compound, a thioxanthone-based compound, a benzoin-based compound, a triazine-based compound, an oxime-based compound, an aminoketone-based compound, and the like, but is not necessarily limited thereto.

Examples of the acetophenone-based compound may be 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may be benzophenone, benzoyl benzoate, benzoyl methyl benzoate, 4-phenyl benzophenone, hydroxybenzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl-4,6-bis(trichloro methyl)-s-triazine, bis(trichloromethyl)-6-styryl-s-triazine, 2-(naphthol-yl)-4,6-bis(trichloromethyl)-s-triazine, 2-(4-methoxynaphthol-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime-based compound may be O-acyloxime-based compound, 2-(O-benzoyloxime)-1-[4-(phenylthio)phenyl]-1,2-octandione, 1-(O-acetyloxime)-1-[9-ethyl-6-(2-methylbenzoyl)-9H-carbazol-3-yl]ethanone, O-ethoxycarbonyl-α-oxyamino-1-phenylpropan-1-one, and the like. Specific examples of the O-acyloxime-based compound may be 1,2-octandione, 2-dimethylamino-2-(4-methylbenzyl)-1-(4-morpholin-4-yl-phenyl)-butan-1-one, 1-(4-phenylsulfanyl phenyl)-butane-1,2-dione-2-oxime-O-benzoate, 1-(4-phenylsulfanyl phenyl)-octane-1,2-dione-2-oxime-O-benzoate, 1-(4-phenylsulfanyl phenyl)-octan-1-oneoxime-O-acetate, 1-(4-phenylsulfanyl phenyl)-butan-1-oneoxime-O-acetate, and the like.

Examples of the aminoketone-based compound may be 2-benzyl-2-dimethylamino-1-(4-morpholinophenyl)-butanone-1, and the like.

The photopolymerization initiator may further include a carbazole-based compound, a diketone-based compound, a sulfonium borate-based compound, a diazo-based compound, an imidazole-based compound, a biimidazole-based compound, and the like, besides the compounds.

The photopolymerization initiator may be used with a photosensitizer capable of causing a chemical reaction by absorbing light and becoming excited and then, transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

Examples of the thermal polymerization initiator may be peroxide, specifically benzoyl peroxide, dibenzoyl peroxide, lauryl peroxide, dilauryl peroxide, di-tert-butyl peroxide, cyclohexane peroxide, methyl ethyl ketone peroxide, hydroperoxide (e.g., tert-butyl hydroperoxide, cumene hydroperoxide), dicyclohexyl peroxydicarbonate, 2,2-azo-bis(isobutyronitrile), t-butyl perbenzoate, and the like, for example 2,2′-azobis-2-methylpropinonitrile, but are not necessarily limited thereto and any of which is well known in the art may be used.

The polymerization initiator may be included in an amount of 0.01 wt % to 5 wt %, or for example, 0.1 wt % to 3 wt %, based on the total amount of the curable composition. If the polymerization initiator is included in the ranges, it is possible to obtain excellent reliability due to sufficient curing during exposure or thermal curing and to prevent deterioration of transmittance due to non-reaction initiators, thereby preventing deterioration of optical characteristics of the quantum dots.

### Other Additives

For stability and dispersion improvement of the quantum dot, the curable composition according to an embodiment may further include a polymerization inhibitor.

The polymerization inhibitor may include a hydroquinone-based compound, a catechol-based compound, or a combination thereof, but is not necessarily limited thereto. When the curable composition according to an embodiment further includes the hydroquinone-based compound, the catechol-based compound, or the combination thereof, room temperature crosslinking during exposure after coating the curable composition may be prevented.

For example, the hydroquinone-based compound, the catechol-based compound, or the combination thereof may be hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis(1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′)aluminum, or a combination thereof, but are not necessarily limited thereto.

The hydroquinone-based compound, the catechol-based compound, or the combination thereof may be used in a form of dispersion. The polymerization inhibitor in a form of dispersion may be included in an amount of 0.001 wt % to 3 wt %, or for example 0.1 wt % to 2 wt % based on a total amount of the curable composition. When the polymerization inhibitor is included in the ranges, passage of time at room temperature may be solved and simultaneously sensitivity deterioration and surface delamination phenomenon may be prevented.

In addition, the curable composition according to an embodiment may further include malonic acid; 3-amino-1,2-propanediol; a silane-based coupling agent; a leveling agent; a fluorine-based surfactant; or a combination thereof in order to improve heat resistance and reliability.

For example, the curable composition according to embodiment may further include a silane-based coupling agent having a reactive substituent such as a vinyl group, a carboxyl group, a methacryloxy group, an isocyanate group, an epoxy group, and the like in order to improve close contacting properties with a substrate.

Examples of the silane-based coupling agent may be trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-epoxycyclohexylethyltrimethoxysilane, and the like, and these may be used alone or in a mixture of two or more.

The silane-based coupling agent may be used in an amount of 0.01 parts by weight to 10 parts by weight based on 100 parts by weight of the curable composition. If the silane-based coupling agent is included within the range, close contacting properties, storage capability, and the like are improved.

In addition, the curable composition may further include a surfactant, for example a fluorine-based surfactant as needed in order to improve coating properties and inhibit generation of spots, that is, improve leveling performance.

The fluorine-based surfactant may have a low weight average molecular weight of 4,000 g/mol to 10,000 g/mol, and specifically 6,000 g/mol to 10,000 g/mol. In addition, the fluorine-based surfactant may have a surface tension of 18 mN/m to 23 mN/m (measured in a 0.1% polyethylene glycol monomethylether acetate (PGMEA) solution). If the fluorine-based surfactant has a weight average molecular weight and a surface tension within the ranges, leveling performance may be further improved, and excellent characteristics may be provided when slit coating as high-speed coating is applied since film defects may be less generated by preventing a spot generation during the high-speed coating and suppressing a vapor generation.

Examples of the fluorine-based surfactant may be, BM-1000®, and BM-1100® (BM Chemie Inc.); MEGAFACE F 142D®, F 172®, F 173®, and F 183® (Dainippon Ink Kagaku Kogyo Co., Ltd.); FULORAD FC-135®, FULORAD FC-170C®, FULORAD FC-430®, and FULORAD FC-431® (Sumitomo 3M Co., Ltd.); SURFLON S-112®, SURFLON S-113®, SURFLON S-131®, SURFLON S-141®, and SURFLON S-145® (ASAHI Glass Co., Ltd.); and SH-28PA®, SH-190®, SH-193®, SZ-6032®, and SF-8428®, and the like (Toray Silicone Co., Ltd.); F-482, F-484, F-478, F-554 and the like of DIC Co., Ltd.

In addition, the curable composition according to an embodiment may include a silicone-based surfactant in addition to the fluorine-based surfactant. Specific examples of the silicone-based surfactant may be TSF400, TSF401, TSF410, TSF4440, and the like of Toshiba silicone Co., Ltd., but are not limited thereto.

The surfactant may be included in an amount of 0.01 parts by weight to 5 parts by weight, for example 0.1 parts by weight to 2 parts by weight based on 100 parts by weight of the curable composition. If the surfactant is included within the ranges, foreign materials are less produced in a sprayed composition.

In addition, the curable composition according to an embodiment may further include other additives such as an antioxidant, a stabilizer, and the like in a predetermined amount, unless properties are deteriorated.

### Solvent

Meanwhile, the curable composition according to an embodiment may be a solvent-type curable composition further including a solvent.

The solvent may for example include alcohols such as methanol, ethanol, and the like; glycol ethers such as ethylene glycol methylether, ethylene glycol ethylether, propylene glycol methylether, and the like; cellosolve acetates such as methyl cellosolve acetate, ethyl cellosolve acetate, diethyl cellosolve acetate, and the like; carbitols such as methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol monomethylether acetate, propylene glycol propylether acetate, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactate esters such as methyl lactate, ethyl lactate, and the like; hydroxy acetic acid alkyl esters such as methyl hydroxyacetate, ethyl hydroxyacetate, butyl hydroxyacetate, and the like; acetic acid alkoxyalkyl esters such as methoxymethyl acetate, methoxyethyl acetate, methoxybutyl acetate, ethoxymethyl acetate, ethoxyethyl acetate, and the like; 3-hydroxypropionic acid alkyl esters such as methyl 3-hydroxypropionate, ethyl 3-hydroxypropionate, and the like; 3-alkoxypropionic acid alkyl esters such as methyl 3-methoxypropionate, ethyl 3-methoxypropionate, ethyl 3-ethoxypropionate, methyl 3-ethoxypropionate, and the like; 2-hydroxypropionic acid alkyl ester such as methyl 2-hydroxypropionate, ethyl 2-hydroxypropionate, propyl 2-hydroxypropionate, and the like; 2-alkoxypropionic acid alkyl esters such as methyl 2-methoxypropionate, ethyl 2-methoxypropionate, ethyl 2-ethoxypropionate, methyl 2-ethoxypropionate, and the like; 2-hydroxy-2-methylpropionic acid alkyl esters such as methyl 2-hydroxy-2-methylpropionate, ethyl 2-hydroxy-2-methylpropionate, and the like; 2-alkoxy-2-methylpropionic acid alkyl esters such as methyl 2-methoxy-2-methylpropionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; or ketonate esters such as ethyl pyruvate, and the like, and in addition, may be N-methylformamide, N,N-dimethyl formamide, N-methylformanilide, N-methylacetamide, N,N-dimethyl acetamide, N-methylpyrrolidone, dimethylsulfoxide, benzylethylether, dihexylether, acetylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, phenyl cellosolve acetate, and the like, but is not limited thereto.

For example, the solvent may be desirably glycol ethers such as ethylene glycol monoethylether, ethylene diglycolmethylethylether, and the like; ethylene glycol alkylether acetates such as ethyl cellosolve acetate, and the like; esters such as 2-hydroxy ethyl propionate, and the like; carbitols such as diethylene glycol monomethylether, and the like; propylene glycol alkylether acetates such as propylene glycol monomethylether acetate, propylene glycol propylether acetate, and the like; alcohols such as ethanol, and the like, or a combination thereof.

For example, the solvent may be a polar solvent including propylene glycol monomethylether acetate, dipropylene glycol methylether acetate, ethanol, ethylene glycoldimethylether, ethylenediglycolmethylethylether, diethylene glycoldimethylether, 2-butoxyethanol, N-methylpyrrolidine, N-ethylpyrrolidine, propylene carbonate, γ-butyrolactone, or a combination thereof.

The solvent may be included in an amount of 40 wt % to 80 wt %, for example, 45 wt % to 80 wt %, based on a total amount of the curable composition. If the solvent is within the range, the solvent-type curable composition has appropriate viscosity and thus may have excellent coating property when coated in a large area through spin-coating and slit-coating.

Another embodiment provides a cured layer produced using the aforementioned curable composition, a color filter including the cured layer, and a display device including the color filter.

One of methods of producing the cured layer may include coating the curable composition and solvent-type curable composition on a substrate using an ink-jet spraying method to form a pattern (S1); and curing the pattern (S2).

### (S1) Formation of Pattern

The curable composition may desirably be coated to be 0.5 μm to 20 μm on a substrate in an ink-jet spraying method. The ink-jet spraying method may form a pattern by spraying a single color per each nozzle and thus repeating the spraying as many times as the needed number of colors, but the pattern may be formed by simultaneously spraying the needed number of colors through each ink-jet nozzle in order to reduce processes.

### (S2) Curing

The obtained pattern is cured to obtain a pixel. Herein, the curing method may be thermal curing or photocuring process. The thermal curing process may be performed at greater than or equal to 100° C., desirably, in a range of 100° C. to 300° C., and more desirably, in a range of 160° C. to 250° C. The photocuring process may include irradiating an actinic ray such as a UV ray of 190 nm to 450 nm, for example 200 nm to 400 nm. As a light source used for irradiation, a low-pressure mercury lamp, high-pressure mercury lamp, ultra-high-pressure mercury lamp, metal halide lamp, argon gas laser, i-line, KrF, ArF, I—ArF, EUV, X-ray, electron beam, etc. may be used as needed.

Another method of producing the cured layer may include producing a cured layer using a lithography method using the aforementioned composition, and the producing method is as follows.

### (1) Coating and Film Formation

The aforementioned curable composition is coated to have a desired thickness, for example, a thickness ranging from 2 μm to 10 μm, on a substrate which undergoes a predetermined pretreatment, using a spin or slit coating method, a roll coating method, a screen-printing method, an applicator method, and the like. Then, the coated substrate is heated at a temperature of 70° C. to 90° C. for 1 minute to 10 minutes to remove a solvent and to form a film.

### (2) Exposure

The resultant film is irradiated by an actinic ray such as a UV ray of 190 nm to 450 nm, for example 200 nm to 400 nm after putting a mask with a predetermined shape to form a desired pattern. As a light source used for irradiation, a low-pressure mercury lamp, high-pressure mercury lamp, ultra-high-pressure mercury lamp, metal halide lamp, argon gas laser, i-line, KrF, ArF, I—ArF, EUV, X-ray, electron beam, etc. may be used as needed.

Exposure process uses, for example, a light dose of 500 mJ/cm² or less (with a 365 nm sensor) when a high-pressure mercury lamp is used. However, the light dose may vary depending on types of each component of the curable composition, its combination ratio, and a dry film thickness.

### (3) Development

After the exposure process, an alkali aqueous solution is used to develop the exposed film by dissolving and removing an unnecessary part except the exposed part, forming an image pattern. In other words, when the alkali developing solution is used for the development, a non-exposed region is dissolved, and an image color filter pattern is formed.

### (4) Post-Treatment

The developed image pattern may be heated again or irradiated by an actinic ray and the like for curing, in order to accomplish excellent quality in terms of heat resistance, light resistance, close contacting properties, crack-resistance, chemical resistance, high strength, storage stability, and the like.

### MODE FOR INVENTION

Hereinafter, the present invention is illustrated in more detail with reference to examples. These examples, however, are not in any sense to be interpreted as limiting the scope of the invention.

### Preparation of Surface-Modified Quantum Dot Dispersion

### Preparation Example 1

After putting a magnetic bar in a 3-necked round bottom flask, a green quantum dot dispersion solution (InP/ZnSe/ZnS, quantum dot solid content: 23 wt %; Hansol Chemical) was added. Subsequently, a compound (ligand) represented by Chemical Formula Q was added thereto and then, stirred at 80° C. under a nitrogen atmosphere. When a reaction was completed, after cooling to room temperature (23° C.), the quantum dot reaction solution was added to cyclohexane, catching precipitates. The precipitates were separated from the cyclohexane through centrifugation and sufficiently dried in a vacuum oven for 24 hours, obtaining surface-modified quantum dots.

The surface-modified green quantum dots were stirred in a polymerizable compound for 12 hours, obtaining a surface-modified quantum dot dispersion (QD solid: 23 wt %).

(*Synthesis of Compound represented by Chemical Formula Q: 100 g of PH-4 (Hannong Chemicals Inc.) was added in a 2-necked round bottom flask and sufficiently dissolved in 300 mL of THF. Subsequently, 15.4 g of NaOH and 100 mL of water were added thereto at 0° C. and sufficiently dissolved therein until a transparent solution was obtained. Then, a solution prepared by dissolving 73 g of para-toluene sulfonic chloride in 100 mL of THF was slowly injected thereinto at 0° C. Herein, the injection proceeds for 1 hour, and then, the obtained mixture was stirred at room temperature for 12 hours. When a reaction was completed, an excessive amount of methylene chloride was added thereto and then, stirred, and a NaHCO₃ saturated solution was added thereto and then, proceeds with extraction, titration, and moisture removal. After removing the solvent, the residue was dried in a dry oven for 24 hours. 50 g of the dried product was added in a 2-necked round bottom flask and then, sufficiently stirred in 300 mL of ethanol. Subsequently, 27 g of thiourea was added thereto for dispersion and then, refluxed at 80° C. for 12 hours. After injecting an aqueous solution obtained by dissolving 4.4 g of NaOH in 20 mL of water thereinto, an excessive amount of methylene chloride was added thereto, while further stirring for 5 hours, and then, stirred, and a hydrochloric acid aqueous solution was added thereto and then, proceeds sequentially with extraction, titration, moisture removal, and solvent removal. Drying in a vacuum oven was performed for 24 hours, obtaining a compound represented by Chemical Formula Q.)

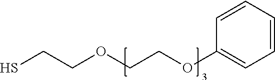

### (Preparation of Curable Compositions)

### Examples 1 to 6 and Comparative Example 1

Each of the curable compositions of Examples 1 to 6 and Comparative Example 1 was prepared to have a composition shown in Table 1 by using the following components.

Specifically, the quantum dot dispersion was weighed and then, mixed with a polymerizable compound and diluted with an electrolyte and then, stirred for 5 minutes. Subsequently, a polymerization initiator was added thereto, and a light scatterer was added thereto. Then, the corresponding crude liquid was stirred for 1 hour, preparing curable compositions.

### (A) Quantum Dots

Surface-modified green quantum dot dispersion prepared from Preparation Example 1

### (B) Polymerizable Compound

Compound represented by Chemical Formula 1-1 (M200, Miwon Chemical Co.)

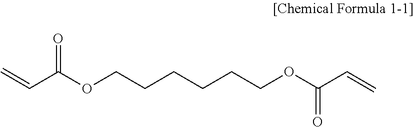 [SMILES: C=CC(=O)OCCCCCCOC(=O)C=C]

### (C) Electrolyte

(C-1) Ionic liquid (1-Butyl-3-methylimidazolium tetrafluoroborate) (Sigma-Aldrich Co., Ltd.)
(C-2) Ionic liquid (Ethylmethyl imidazolium tetrafluoroborate) (Sigma-Aldrich Co., Ltd.)
(C-3) Ionic salt (tetrabutylammonium phosphate) solid at 23° C. (Sigma-Aldrich Co., Ltd.)
(C-4) Ionic salt (5-azoniaspiro[4.4]nonane tetrafluoroborate) which was solid at 23° C. (Sigma-Aldrich Co., Ltd.)
(C-5) Conductive polymer (polyphenylene sulfide) (Sigma-Aldrich Co., Ltd.)
(C-6) Conductive polymer (polypyrrole) (Sigma-Aldrich Co., Ltd.)

### (D) Light Scatterer

Titanium dioxide dispersion (TiO₂ solid content: 20% by weight, average particle diameter: 200 nm, Dito Technology Co., Ltd.)

### (E) Polymerization Initiator

TPO-L (Polynetron Co.)

TABLE 1
(unit: wt %)

| | | Example | Example | Example | Example | Example | Example | Comparative |
|---|---|---|---|---|---|---|---|---|
| | | 1 | 2 | 3 | 4 | 5 | 6 | Example 1 |
| (A) Quantum dots | | 36 | 36 | 36 | 36 | 36 | 36 | 36 |
| (B) Polymerizable | | 57.25 | 57.25 | 57.25 | 57.25 | 57.25 | 57.25 | 57.5 |
| compound | | | | | | | | |
| (C) Electrolyte | (C-1) | 0.25 | — | — | — | — | — | — |
| | (C-2) | — | 0.25 | — | — | — | — | — |
| | (C-3) | — | — | 0.25 | — | — | — | — |
| | (C-4) | — | — | — | 0.25 | — | — | — |
| | (C-5 | — | — | — | — | 0.25 | — | — |
| | (C-6 | — | — | — | — | — | 0.25 | — |

| | | | | | | | |
|---|---|---|---|---|---|---|---|
| (D) Light scatterer | 5 | 5 | 5 | 5 | 5 | 5 | 5 |
| (E) Polymerization | 1.5 | 1.5 | 1.5 | 1.5 | 1.5 | 1.5 | 1.5 |
| initiator | | | | | | | |

### Evaluation: Ink Jetting Stability

The solvent-free curable compositions (spinning solutions) according to Examples 1 to 6 and Comparative Example 1 were checked with respect to spinnability, while respectively varying an electrical conductivity, and the results are shown in Table 2. Ink jetting stability of the solvent-free curable compositions was evaluated according to the following reference.

### (Evaluation Criteria for Ink Jetting Stability)

O: when electrospinning stably proceeds, so that most of a solution may be accumulated/maintained in a fiber form
Δ: when electrospinning is possible but intermittently unstable
X: when electrospinning does not proceed smoothly, so that a solution may be sprayed without forming a fiber form, or even if formed into the fiber form, when the electrospinning is unstable and difficult to control

TABLE 2

| Electrical | | | | | | | |
|---|---|---|---|---|---|---|---|
| conductivity | Example | Example | Example | Example | Example | Example | Comparative |
| (μS/cm) | 1 | 2 | 3 | 4 | 5 | 6 | Example 1 |
| 0 | X | X | X | X | X | X | X |
| 0.05 | Δ | Δ | X | X | X | X | X |
| 0.1 | ◯ | ◯ | X | X | X | X | X |
| 0.3 | ◯ | ◯ | ◯ | ◯ | ◯ | ◯ | X |
| 0.5 | ◯ | ◯ | ◯ | ◯ | ◯ | ◯ | X |
| 1 | ◯ | ◯ | ◯ | ◯ | Δ | Δ | Δ |
| 2.5 | ◯ | ◯ | ◯ | Δ | Δ | X | X |
| 3 | X | X | X | X | X | X | X |

Referring to Table 2, as electrospinning very stably proceeds, the curable composition according to an embodiment exhibited excellent inkjetting stability. Accordingly, the curable composition according to an embodiment may be easily inferred to achieve stable and reliable patterning without intermittent breakage.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A curable composition, comprising
(A) quantum dots;
(B) a polymerizable compound; and
(C) an electrolyte, and
wherein the curable composition has an electrical conductivity of 0.1 μS/cm to 2.5 μS/cm.

2. The curable composition of claim 1, wherein
the electrolyte includes an ionic compound, a conductive polymer, or a combination thereof.

3. The curable composition of claim 2, wherein
the ionic compound is a compound composed of a combination of a cation and an anion, and the cation is any one cation selected from Group 1:
[Group 1]
a substituted or unsubstituted ammonium, substituted or unsubstituted imidazolium, substituted or unsubstituted oxazolium, substituted or unsubstituted piperidinium, substituted or unsubstituted pyrazinium, substituted or unsubstituted pyrazolium, substituted or unsubstituted pyridazinium, substituted or unsubstituted pyridinium, substituted or unsubstituted pyrimidinium, substituted or unsubstituted pyrrolidinium, substituted or unsubstituted pyrrolinium, substituted or unsubstituted pyrrolium, substituted or unsubstituted triazolium, and

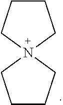

4. The curable composition of claim 2, wherein
the ionic compound is a compound composed of a combination of a cation and an anion, and the anion is any one anion selected from Group 2:
[Group 2]
F⁻, Cl⁻, Br⁻, I⁻, Br₃⁻, NO₃⁻, N(CN)₂⁻, BF₄⁻, ClO₄⁻, FCrO₃⁻, ClCrO₃⁻, SO₄²⁻, RSO₃⁻ (wherein R is a C1 to C10 alkyl group or a C6 to C20 aryl group), RCOO⁻ (wherein R is a C1 to C10 alkyl group or a C6 to C20 aryl group), H₂PO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, (CF₃SO₃)₂, (CF₂CF₂SO₃⁻)₂, (CF₃SO₃)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, and CH₃CO₂⁻.

5. The curable composition of claim 2, wherein
the ionic compound includes an ionic liquid, a solid ionic salt, or a combination thereof.

6. The curable composition of claim 2, wherein
The conductive polymer includes at least one selected from the group consisting of polyphenylene or a derivative thereof, polyphenylenevinylene or a derivative thereof, polyphenylene sulfide or a derivative thereof, polyfluorene or a derivative thereof, poly(p-pyridine) or a derivative thereof, poly(p-pyridal vinylene) or a derivative thereof, polypyrrole or a derivative thereof, polyaniline or a derivative thereof, polythiophene or a derivative thereof, polythiophenvinylene or a derivative thereof, polyfuran or a derivative thereof, and polyacetylene or a derivative thereof.

7. The curable composition of claim 1, wherein
the electrolyte is included in an amount of 0.1 wt % to 1 wt % based on the total amount of the curable composition.

8. The curable composition of claim 1, wherein
the polymerizable compound is a compound represented by Chemical Formula 1: 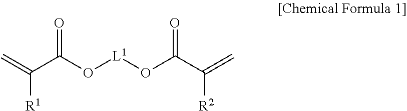
wherein, in Chemical Formula 1,
R¹ and R² are each independently a hydrogen atom or a methyl group, and
L¹ is a substituted or unsubstituted C1 to C30 alkylene group or *-L^{a}-O-L^{b}-* (wherein L^{a} and L^{b} are each independently a substituted or unsubstituted C1 to C20 alkylene group).

9. The curable composition of claim 8, wherein
the compound represented by Chemical Formula 1 is represented by any one of Chemical Formulas 1-1 to 1-3:

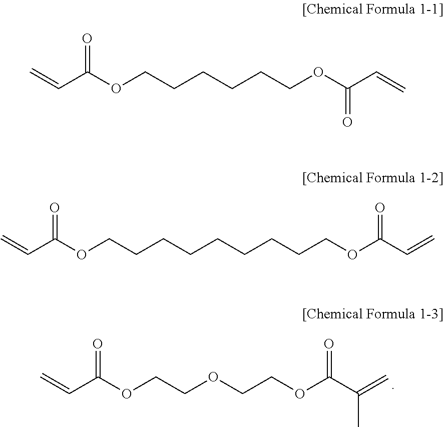

10. The curable composition of claim 1, wherein
the quantum dots are surface-modified quantum dots with any one or a combination thereof, represented by Chemical Formulas 2 to 15: 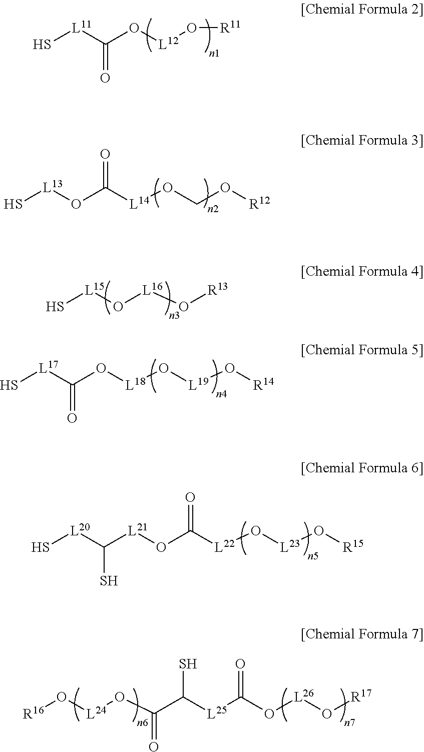
wherein, in Chemical Formulas 2 to 7,
R¹¹ to R¹⁷ are each independently a substituted or unsubstituted C1 to C10 alkyl group or a substituted or unsubstituted C6 to C20 aryl group,
L¹¹ to L²⁶ are each independently a substituted or unsubstituted C1 to C10 alkylene group, and
n1 to n7 are each independently an integer of 0 to 10, 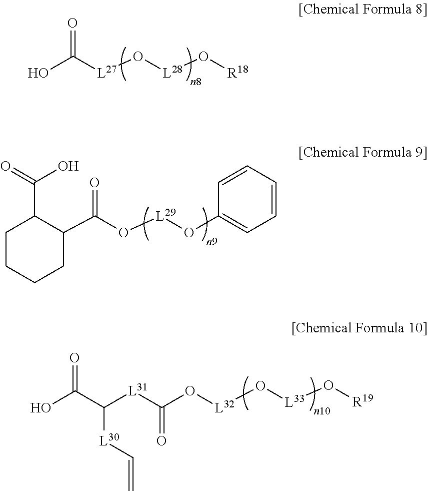
wherein, in Chemical Formulas 8 to 10,
R¹⁸ and R¹⁹ are each independently a substituted or unsubstituted C1 to C10 alkyl group,
L²⁷ to L³³ are each independently a substituted or unsubstituted C1 to C10 alkylene group, and
n8 to n10 are each independently an integer of 0 to 10, 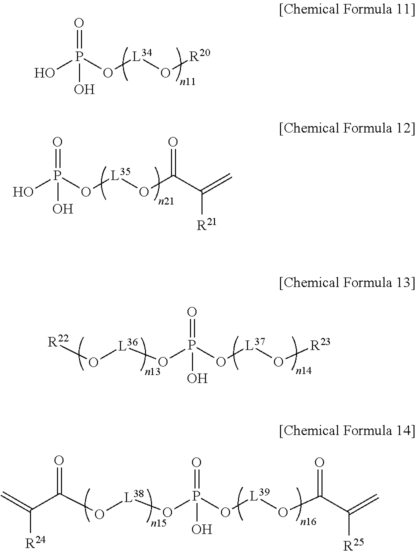
wherein, in Chemical Formulas 11 to 14,
R²⁰ to R²⁵ are each independently a hydrogen atom or a substituted or unsubstituted C1 to C10 alkyl group,
L³⁴ to L³⁹ are each independently a substituted or unsubstituted C1 to C10 alkylene group, and
n11 to n16 are each independently an integer of 0 to 10, 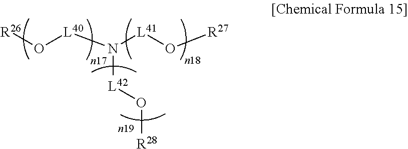
wherein, in Chemical Formula 15,
R²⁶ to R²⁸ are each independently a substituted or unsubstituted C1 to C10 alkyl group,
L⁴⁰ to L⁴² are each independently a substituted or unsubstituted C1 to C10 alkylene group, and
n17 to n19 are each independently an integer of 0 to 10.

11. The curable composition of claim 1, wherein
the quantum dots have a maximum fluorescence emission wavelength at 500 nm to 680 nm.

12. The curable composition of claim 1, wherein
the curable composition further includes a light scatterer.

13. The curable composition of claim 12, wherein
the light scatterer further includes barium sulfate, calcium carbonate, titanium dioxide, zirconia, or a combination thereof.

14. The curable composition of claim 1, wherein
the curable composition is a solvent-free curable composition.

15. The curable composition of claim 14, wherein
the quantum dots are included in an amount of 5 wt % to 70 wt % based on the total weight of the solvent-free curable composition.

16. The curable composition of claim 14, wherein
the polymerizable compound is included in an amount of 30 wt % to 95 wt % based on the total weight of the solvent-free curable composition.

17. The curable composition of claim 1, wherein
the curable composition further includes a polymerization initiator.

18. The curable composition of claim 1, wherein
the curable composition further includes a solvent.

19. The curable composition of claim 18, wherein
based on a total weight of the curable composition, the curable composition includes
1 wt % to 40 wt % of the (A) quantum dots;
1 wt % to 20 wt % of the (B) polymerizable compound;
0.1 wt % to 1 wt % of the (C) electrolyte; and
40 wt % to 80 wt % of the solvent.

20. The curable composition of claim 1, wherein
the curable composition further includes a polymerization inhibitor; malonic acid; 3-amino-1,2-propanediol; a silane-based coupling agent; a leveling agent; a fluorine-based surfactant; or a combination thereof.

21. A cured layer produced using the curable composition of claim 1.

22. A display device including the cured layer of claim 21.
